(19) United States
(12) Patent Application Publication
(10) Pub. No.: US 2025/0231952 A1
(43) Pub. Date: Jul. 17, 2025

(54) SYSTEM AND METHOD FOR RANKING SEARCH ENGINE RESULTS

(71) Applicant: Y.E. Hub Armenia LLC, Yerevan (AM)

(72) Inventors: Aleksandr VOROBEV, Krasnogorsk (RU); Aleksei ZABELIN, Moscow (RU); Andrey PLOSKONOSOV, Kaluga (RU)

(21) Appl. No.: 19/017,204

(22) Filed: Jan. 10, 2025

(30) Foreign Application Priority Data
Jan. 12, 2024 (RU) 2024100717

(51) Int. Cl. G06F 16/2457; G06F 16/953

(52) U.S. Cl. CPC G06F 16/24578; G06F 16/953

(57) ABSTRACT

There are discloses methods and systems for generating a search engine results page (SERP). The method is executable at a server executing a search engine, the server being accessible via a communication network by at least one electronic device. The method comprises, as part of generating a search result list, the search result list containing a first search result and a second search result, predicting a first interest parameter for the first search result; predicting a second interest parameter for the second search result; predicting a usefulness parameter for the first search result, the predicting being at least partially based on the first interest parameter and the second interest parameter; adjusting a position of the first search result within the ranked search result list based on the predicted usefulness parameter, the adjusting resulting in the first search result being at an adjusted position within the ranked search result list.

### CROSS-REFERENCE

The present application claims priority to Russian Patent Application No. 2024100717, entitled “Method and System for Ranking Search Engine Results”, filed Jan. 12, 2024, the entirety of which is incorporated herein by reference.

### FIELD

The present technology relates to search engines in general and specifically to a method and apparatus for ranking search results. Systems and methods described herein determine rank positions of elements by a search ranking system.

### BACKGROUND

The Internet provides access to a wide variety of resources, for example, video files, image files, audio files, or Web pages, including content for particular subjects, reference articles, or news articles. A typical user can select a particular web resource for access using a browser application executed on an electronic device, be it a desktop computer, a laptop computer, a tablet or a smartphone. There is a number of commercially available browsers to execute such a function, GOOGLE CHROME browser, INTERNET EXPLORER browser, YANDEX browser and the like. The user can type in a Universal Resource Locator (URL) of the web resource that is desired for access or, alternatively, the user can select (click or otherwise actuate) a hyperlink to the URL of the web resource.

A given user may not know a specific web resource that the user wants to access, but rather knows a type of information the user is looking for. In those circumstances, the user may use a so-called search engine to locate one or more web resources that provide information that the user is interested in. To that extent, the user can submit a “search query” and the search engine returns a ranked list of search results that are responsive to the search query in a form of a Search Engine Results Page (or SERP for short). Various types of content may be provided to a user of a search engine service in response to the user search query. For example, the search service may provide to the user: native-type content (generated by content-authors within the recommendation system service), web-type content, video-type content, image-type content, news-type content, audio-type content, and the like.

With reference to FIG. 6, there is provided a screen shot 9100 of a typical SERP provided by a prior art search engine, in this case, the search engine being implemented as YANDEX search engine, provided by Yandex LLC of 16, Leo Tolstoy St., Moscow 119021, Russia. For illustration purposes, the search engine that generated the screen shot 9100 is executed on a desktop computer.

Within the illustrated scenario, the user has typed into a search query interface 9102 of the search engine a search query “Ecuador”, presumably interested in information about Ecuador. As will be appreciated, the search query “Ecuador” does not have a clear search intent, as the user typing in such the query may be interested in getting information about the country Ecuador, about the song “Ecuador” by Sash!, getting news about Ecuador or getting pictures of Ecuadorian landscapes.

The search query entered into the search query interface is transmitted to a search engine server (not depicted) and the search engine server executes a search and returns data for generating a SERP 9104. The SERP 9104 is configured to convey to the user one or more search results. These search results, as well as their presentation, will vary, but generally and as an example only will include: a first search result 9106, a second search result 9108, a third search result 9110 and a plurality of additional search results 9112. Some of these search results can be considered “web search results” and some of these search results can be considered to be “vertical search results”. The web search results (such as the first search result 9106 and the third search result 9110, for example) are search results returned by a web search module of the search engine and are generally web resources available on the Internet (in these case, these are Russian article about Ecuador on WIKIPEDEA and Lonely Planet article about Ecuador, respectively). The vertical search results (such as the second search result 9108, for example) are search results returned by one or more of the vertical search modules of the search engine (in this case, the second search result 9108 is implemented as a “widget” presenting results of the video vertical—i.e. one or more videos that are responsive to the search query “Ecuador”).

Vertical search results are tailored to a specific category, topic, or vertical within a broader search engine. Instead of displaying general web page listings, vertical search results focus on a particular type of content or data. Common verticals include images, videos, news articles, local listings, shopping products, and more. For example, a search for “best smartphones,” a search engine may provide a section of vertical search results that specifically displays smartphone product listings, prices, and reviews.

Widgets are small interactive or informative elements that appear within a search engine results page. They are designed to provide additional functionality or information related to the search query. Widgets can take various forms, such as: Knowledge Panels (providing structured information about a notable entity), featured snippets (providing concise answers or summaries that appear prominently at the top of the search results), video thumbnails (providing a preview image of a video along with its title, duration, and source), image thumbnails (providing a preview of images before clicking on them), a local pack (providing a map and a list of local businesses or places related to a location-based search query), shopping widgets (providing product listings, prices, and options for online shopping), etc., Widgets may enhance the user experience by providing quick access to relevant information or media content directly on the search results page, reducing the need to click through to individual web pages.

The SERP 9104 may also include a vertical domain actuator 9120, which is configured to allow the user to select (and change) a particular search domain—in the illustrated example, the user can cause the SERP 9104 to switch from the current “web” view of search results, to one or more vertical domains, including: “maps”, “images”, “news”, “videos” and the like. The number and exact types of the vertical domains can differ, but vertical domains allow the user to switch to a particular type of search results. For example, if the user was interested in images of Ecuador, the user could switch to the “images” vertical, which would cause the SERP 9104 to change and to present to the user search results from the “images” vertical, the search result being images that are responsive the search query “Ecuador”.

One will easily appreciate that the search results shown as part of the plurality of additional search results 9112 is not an entirety of all search results that the search engine has generated in response to the search query. On the contrary, the plurality of additional search results 9112 includes many more search results that are not visible within the screen shot 9100, due to the limitations of the real estate of a display of the electronic device. Furthermore, search engines typically “split” search results in several screens and to that end a scroll actuator 9116 is provided to switch to the “next” portion of the SERP 9104. The scroll actuator 9116 can be an arrow, a numeric indicator of screens within the SERP 9104 or the like.

One of the technical challenges for the search engine server, is to select and rank search results to generate the SERP 9104 that is “time effective” for the user. What this means is that search engines strive to put the most relevant search results (i.e. the search results that are more likely to satisfy the user's search intent” towards the “top” of the SERP 9104. In other words, the search results presented on higher positions of the SERP 9104 (i.e. first n-number of search results shown on the first page of the SERP 9104) should be able to satisfy the user's search intent. When a user has to “scroll” through the search results to the second, third, etc. pages of the SERP 9104, the “quality” of the SERP 9104 may be deemed to be lower than desired.

Search engines employ various techniques and algorithms for ranking search results. Typically, a machine learning algorithm is used for ranking the search results into the SERP 9104. Various techniques are available for ranking search results. Just as an example, some of the known techniques for ranking search results by relevancy are based on some or all of: (i) how popular a given search query or a response thereto is in other prior searches (web or vertical); (ii) how many results have been returned by either the vertical or web search modules; (iii) whether the search query contains any determinative terms (such as “images”, “movies”, “weather” or the like), (iv) how often a particular search query is typically used with determinative terms by other users; and (v) how often other uses performing a similar search have selected a particular resource or a particular vertical search results when results were presented using the SERP 9104.

Some search engines can provide various types of content according to either (i) unsupervised proportions of types of content or (ii) pre-determined proportions of types of content. However, the search engines need to “blend” various types of contents in order to provide more relevant search results. In other words, the search engine needs to rank different types of contents (web search results, vertical search results, widgets, etc.) which is a challenging task. For example, the engine blends different type of the search results in response to a “Rihanna” search requests: videos, images, documents (i.e. Wikipedia pages), music tracks, etc.

Due to different nature of the search results, the search engine needs to decide how useful each type of the search result is going to be to the user. This may be performed based on a so-called blending algorithm or simply a blender algorithm, which is a machine learning algorithm. The blender needs to determine a specific search result element rank based on its contents and type. The blender algorithm accepts features inputs of the search request, the user and the web document.

One metric maximized during training of a blender algorithm is surplus. In the case of each search result, surplus generally relates to a winner (win) or a loser (loss) situation, wherein win shows the search result to be “useful” (a user selection or a dwell time may be indicative of the specific web element being useful). Loss, by contrast, is associated with a user interaction with a web element located below a particular search element in the SERP. Such win and loss logic is depictive of whether a web element is going to be selected by a user or not.

To rank different type of contents, the blender algorithm provides a usefulness score. Based on the usefulness score, a selected element is determined to be a winning element or a losing element. The winning element may be displayed in the search results while the losing element may be demoted in ranking or excluded from the SERP in the search results. Such a score shows (based on receiving values from 0 to 1) how useful a selected document or other element is going to be showed in ensemble with the other search results elements.

One challenge for the usefulness score is to determine a positional bias associated with how relevance for the same element differs depending on the SERP position. I.e., an image element from the search results related to a “Rihanna” query is generally non-useful for the user if it is shown at 50+ position outside of the first pages of the SERP. The user will likely neither see nor select it. Put it another way, the usefulness drops in correlation with the location of the element in the search results.

U.S. Pat. No. 10,642,905 B2 discloses a system and method for ranking search engine results. The '905 reference focuses on the methods for predicting an “interest parameter” for the search results, wherein the parameter is indicative of the clicking \ non-clicking likelihood of a user clicking on a selected search result. The reference discloses the ranking prediction routine based on applying several machine learning algorithms for determining a win component, a loss component and a usefulness parameter based on the difference between the win and the loss components. This document discloses an algorithm for generating (predicting) each of the components (a win component and a loss component) which are then used in a function of generating a usefulness parameter. The usefulness function allows predicting of values of the usefulness parameter based on the values of win and loss components.

The respective algorithms of U.S. Pat. No. 10,642,905 have a single class win and loss metric. For a selected element a difference between a loss and a win associated with a search element is determined to rank search results.

In some ranking algorithms when the usefulness score is 0, a search element is not shown at all—it “totally loses” and is not included in the search results on the basis that the probability of the user selecting such an element is deemed insignificant. The remaining elements are ranked based on, inter alia, the usefulness score having values >0, from 0 to 1. That is, where the win-loss function of the prior art produces a zero or negative metric, the search result is not ranked, which can lead to search results of being deemed totally irrelevant when this may not be the case were an even more sophisticated algorithm utilized.

### SUMMARY

It is an object of the present invention to ameliorate at least some of the inconveniences present in the prior art. That is, it is desirable to provide a blender algorithm in systems and methods for ranking search results that is able to rank previously totally losing search results so as to provide an improved search engine under evaluation. Further, the algorithm of systems and methods is desirably able to handle more data and features in a processing efficient way.

In a first aspect, a method of generating a Search Engine Results Page (SERP) is provided. The SERP is to be provided to an electronic device associated with a user of a search engine hosted by a server, the server being communicatively coupled with the electronic device. The method is executable by the server and comprises: acquiring query data from the electronic device, the query data being indicative of a query submitted by the user; determining a set of web content elements based on the query data including a given web content element, the set of web content elements including relevant search results for the query; generating context data from the set of web content elements and the query data; feeding the context data to a model, the model being a multiclassification model for a plurality of classes, the plurality of classes including two classes dedicated to a given ranking position on the SERP. The two classes are: a win-dedicated class indicative of a predicted benefit of the given web content element being ranked at the given ranking position on the SERP, and a loss-dedicated class indicative of a predicted detriment of the given web content element being ranked at the given ranking position on the SERP. The method includes generating a metric value for a given web content element-position pair, the given web content element-position pair including the given web content element and the given ranking position. The metric value is a difference between a predicted benefit value of the win-dedicated class by the model for the given web content element and a predicted detriment value of the loss-dedicated class by the model for the given web content element. The metric value is indicative of an overall usefulness of ranking the given web content element at the given ranking position. The method includes generating the SERP with the given web content element being ranked at the given ranking position based on the metric value.

In embodiments, the model is configured to output probabilities for each ranking position of a set of ranking positions for each of the win dedicated class and the loss dedicated class and to determine the metric value for each of the ranking positions for the set of ranking positions, wherein the maximum difference is selected as the given ranking position for the ranking position of the given web content element in the SERP.

In embodiments, the given web content element is a widget to be inserted in web documents included in the relevant search results for the query.

In embodiments, the context data includes ranked web documents from a first search engine.

In embodiments, the win-dedicated class corresponds to a probability of a user engagement with the given web content element at the given ranking position.

In embodiments, the loss-dedicated class corresponds to a probability of a user engagement with another web content element below the given ranking position.

In another aspect, a method of training a model for ranking objects on a Search Engine Results Page (SERP) is provided. The SERP is to be provided to an electronic device associated with a user of a search engine hosted by a server. The server is communicatively coupled with the electronic device. The method is executable by the server and comprises: acquiring query data associated with a training query, the training query being a previously submitted query to the search engine for which a training web content element has been provided as a search result at a given ranking position; acquiring context data associated with the training web content element, the context data including the query data; acquiring user-interaction data associated with the training web content element, the user-interaction data being indicative of (i) a benefit of the training web content element having been ranked at the given ranking position in response to the training query and (ii) a detriment of the training web content element having been ranked at the given ranking position in response to the training query; generating two training sets for a training query-web content element pair, the training query-web content element pair including the training query and the training web content element. The two training sets include a positive training set having an input and a first label, the input having the context data, the first label being indicative of a ground-truth benefit of the training web content element having been ranked at the given ranking position in response to the query. The two training sets include a negative training set having the input and a second label, the second label being indicative of a ground-truth detriment of the training web content element having been ranked at the given ranking position in response to the query. The method includes training the model using the positive training set and the negative training set. The model is a multiclassification model for a plurality of classes. The plurality of classes includes two classes dedicated to the given ranking position, the two classes being: a win-dedicated class indicative of a predicted benefit of the training web content element being ranked at the given ranking position, and a loss-dedicated class indicative of a predicted detriment of the training web content element being ranked at the given ranking position.

In embodiments, the model is configured to output probabilities for each ranking position of a set of ranking positions for each of the win dedicated class and the loss dedicated class.

In embodiments, the training web content element is a widget to be inserted in web documents included in relevant search results for the query.

In embodiments, the win-dedicated class corresponds to a probability of a user engagement with the training web content element at the given ranking position.

In embodiments, the loss-dedicated class corresponds to a probability of a user engagement with another web content element below the given ranking position.

In embodiments, the model is configured to output probabilities for each ranking position of a set of ranking positions for each of the win dedicated class and the loss dedicated class, and wherein the training includes adjusting the model to minimize a difference between the output probabilities and probabilities indicated by the positive training set and the negative training set.

In embodiments, the training includes random data collection by which the given ranking position is randomly selected.

In embodiments, the positive training set represents an example when a user interacted with the training web content element at the given position in the given context; and the negative training set represents an example when a user interacted with the training web content element at a ranking position beneath the given position, and wherein the training adjusts the model M to predict probabilities of both the win dedicated class and the loss dedicated class.

In another aspect, a system for generating a Search Engine Results Page (SERP) is provided. The system includes a server configured to provide the SERP to an electronic device associated with a user of a search engine hosted by the server. The server is communicatively coupled with the electronic device and is configured to: acquire query data from the electronic device, the query data being indicative of a query submitted by the user; determine a set of web content elements based on the query data including a given web content element, the set of web content elements including relevant search results for the query; generate context data from the set of web content elements and the query data; feed the context data to a model, the model being a multiclassification model for a plurality of classes. The plurality of classes includes two classes dedicated to a given ranking position on the SERP. The two classes are: a win-dedicated class indicative of a predicted benefit of the given web content element being ranked at the given ranking position on the SERP, and a loss-dedicated class indicative of a predicted detriment of the given web content element being ranked at the given ranking position on the SERP. The server is configured to generate a metric value for a given web content element-position pair, the given web content element-position pair including the given web content element and the given ranking position. The metric value is a difference between a predicted benefit value of the win-dedicated class by the model for the given web content element and a predicted detriment value of the loss-dedicated class by the model for the given web content element. The metric value is indicative of an overall usefulness of ranking the given web content element at the given ranking position. The servicer is configured to generate the SERP with the given web content element being ranked at the given ranking position based on the metric value.

In embodiments, the model is configured to output probabilities for each ranking position of a set of ranking positions for each of the win dedicated class and the loss dedicated class and to determine the metric value for each of the ranking positions for the set of ranking positions, wherein the maximum difference is selected as the given ranking position for the ranking position of the given web content element in the SERP.

In embodiments, the given web content element is a widget to be inserted in web documents included in the relevant search results for the query.

In embodiments, the context data includes ranked web documents from a first search engine.

In embodiments, the win-dedicated class corresponds to a probability of a user engagement with the given web content element at the given ranking position.

In embodiments, the loss-dedicated class corresponds to a probability of a user engagement with another web content element below the given ranking position.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests, retrieval of historical search sessions) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “a server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a schematic diagram depicting a system, the system being implemented in accordance with non-limiting embodiments of the present technology.

FIG. 2 is a schematic representation of operation of a machine learning algorithm or search engine for ranking search results, in accordance with various embodiments of the present technology.

FIG. 3 is a schematic representation of training of the machine learning algorithm of FIG. 2, in accordance with various embodiments of the present technology.

FIG. 4 depicts a block diagram of a method of ranking search results, the method being executable within the system of FIG. 1 and being implemented in accordance with non-limiting embodiments of the present technology.

FIG. 5 depicts a block diagram of a method of training the machine learning algorithm of FIG. 2, the method being executable within the system of FIG. 1 and being implemented in accordance with non-limiting embodiments of the present technology.

FIG. 6 depicts a screen shot of a typical SERP provided by a prior art search engine.

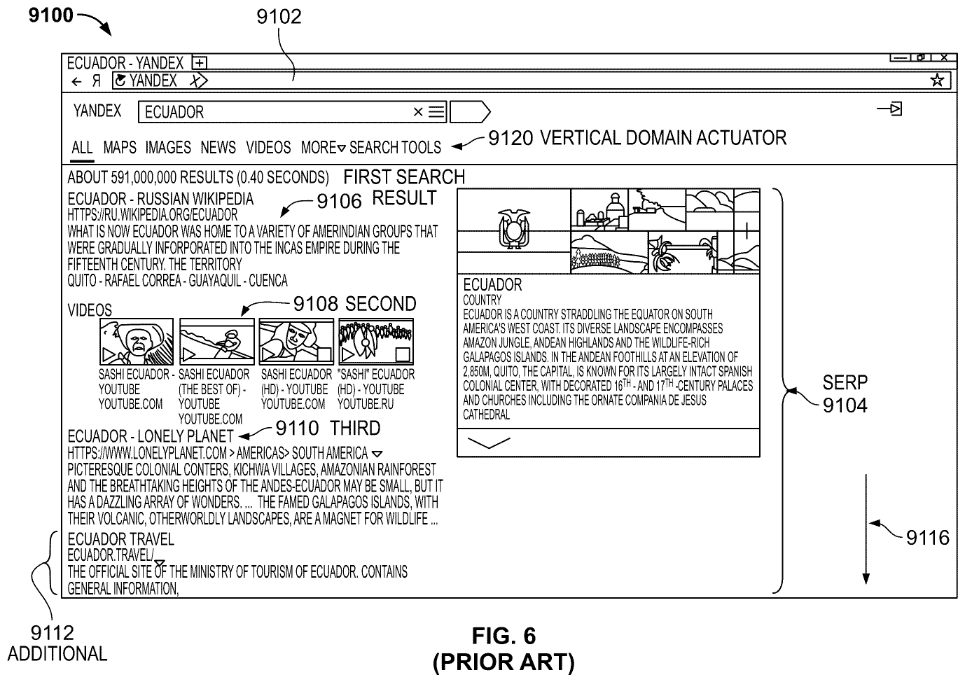

### DETAILED DESCRIPTION

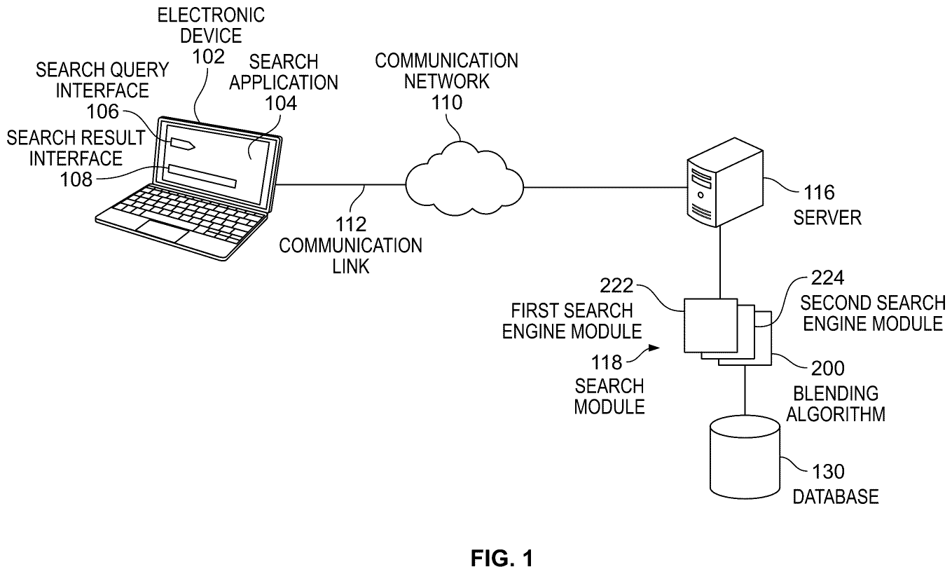

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth herein below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to receive search queries and to conduct searches (e.g., general searches, vertical searches) in response thereto, as well as to generate annotated search indexes in accordance with non-limiting embodiments of the present technology. As such, any system variation configured to process user search queries and generate annotated search indexes can be adapted to execute embodiments of the present technology, once teachings presented herein are appreciated.

The system 100 comprises an electronic device 102. The electronic device 102 is typically associated with a user (not depicted) and, as such, can sometimes be referred to as a “client device” or a “client electronic device”. It should be noted that the fact that the electronic device 102 is associated with the user does not need to suggest or imply any mode of operation-such as a need to log in, a need to be registered, or the like.

The implementation of the electronic device 102 is not particularly limited, but as an example, the electronic device 102 may be implemented as a personal computer (desktops, laptops, netbooks, etc.), a wireless communication device (such as a smartphone, a cell phone, a tablet and the like), as well as network equipment (such as routers, switches, and gateways). The electronic device 102 comprises hardware and/or software and/or firmware (or a combination thereof), as is known in the art, to execute a search application 104. Generally speaking, the purpose of the search application 104 is to enable the user (not depicted) to execute a search, such as a web search using a search engine.

How the search application 104 is implemented is not particularly limited. One example of the search application 104 may include a user accessing a web site associated with a search engine to access the search application 104. For example, the search application can be accessed by typing in an URL associated with Yandex™ search engine at www.yandex.ru. It should be expressly understood that the search application 104 can be accessed using any other commercially available or proprietary search engine.

In alternative non-limiting embodiments of the present technology, the search application 104 may be implemented as a browser application on a portable device (such as a wireless communication device). For example (but not limited to) those implementations, where the electronic device 102 is implemented as a portable device, such as for example, Samsung™ Galaxy™ SIII, the electronic device 102 may be executing a Yandex browser application. It should be expressly understood that any other commercially available or proprietary browser application can be used for implementing non-limiting embodiments of the present technology.

Generally speaking, the search application 104 comprises a search query interface 106 and a search result interface 108. The general purpose of the search query interface 106 is to enable the user (not depicted) to enter his or her query or a “search string”. The general purpose of the search result interface 108 is to provide search results that are responsive to the user search query entered into the search query interface 106.

Also coupled to the communication network is a server 116. The server is accessible by the electronic device 102 via a communication network 110 (the electronic device 102 being just one example of a plethora of other electronic devices, which are not depicted, but which can access the server 116 via the communication network 110).

The server 116 can be implemented as a conventional computer server. In an example of an embodiment of the present technology, the server 116 can be implemented as a Dell™ PowerEdge™ Server running the Microsoft™ Windows Server™ operating system. Needless to say, the server 116 can be implemented in any other suitable hardware and/or software and/or firmware. In the depicted non-limiting embodiments of the present technology, the server 116 is a single server. In alternative non-limiting embodiments of the present technology, the functionality of the server 116 may be distributed and may be implemented via multiple servers.

The electronic device 102 is configured to communicate with the server 116 via the communication network 110 and a communication link 112. In some non-limiting embodiments of the present technology, the communication network 110 can be implemented as the Internet. In other embodiments of the present technology, the communication network 110 can be implemented differently, such as any wide-area communication network, local-area communication network, a private communication network and the like.

How the communication link 112 is implemented is not particularly limited and will depend on how the electronic device 102 is implemented. Merely as an example and not as a limitation, in those embodiments of the present technology where the electronic device 102 is implemented as a wireless communication device (such as a smartphone), the communication link 112 can be implemented as a wireless communication link (such as but not limited to, a 3G communication network link, a 4G communication network link, Wireless Fidelity, or WiFi® for short, Bluetooth® and the like). In those examples where the electronic device 102 is implemented as a notebook computer, the communication link can be either wireless (such as Wireless Fidelity, or WiFi® for short, Bluetooth® or the like) or wired (such as an Ethernet based connection).

The server 116 is communicatively coupled (or otherwise has access) to a search module 118. According to these embodiments of the present technology, the search module 118 performs general and/or vertical searches in response to the user search queries inputted via the search query interface 106 and outputs search results to be presented to the user using the search result interface 108.

Within these non-limiting embodiments of the present technology, the search module 118 comprises or otherwise has access to a database 130. As is known to those of skill in the art, the database 130 stores information associated with a plurality of resources potentially accessible via the communication network (for example, those resources available on the Internet).

The process of populating and maintaining the database 130 is generally known as “crawling”. The implementation of the database 130 is not particularly limited. It should be understood that any suitable hardware for storing data may be used. In some implementations, the database 130 may be physically contiguous with the search module 118, i.e., they are not necessarily separate pieces of hardware, as depicted, although they may be. In the depicted non-limiting embodiments of the present technology, the database 130 is a single database. In alternative non-limiting embodiments of the present technology, the database 130 may be segregated into one or more separate databases (not depicted). These segregated databases may be portions of the same physical database or may be implemented as separate physical entities. For example, one database within, let's say, the database 130 could host the inverted index, while another database within the database 130 could host the resources available, while yet another database within the database 130 could host the features of the search histories pertaining to particular search queries (i.e., the historical search sessions). Needless to say, the above has been provided as an illustration only and several additional possibilities exist for implementing embodiments of the present technology.

The database 130 also stores information and data repressing past search queries, such as: what the users searched for, which search results where presented, which positions a given search result were presented on, which results where selected, whether a given search result was selected, how much time a given user spent on a given past result, how many reformulations a given user submitted and the like. In alternative embodiments, information representative of the past search queries can be stored in a separate database from the database 130.

It should be expressly understood that in order to simplify the description presented herein below, the configuration of the search module 118 and the database 130 has been greatly simplified. It is believed that those skilled in the art will be able to appreciate implementational details for the search module 118 and for components thereof and for the database 130.

In general, a given search query that a given user may type in using the search query interface 106 may be considered to be a series of one or more search terms, and the search terms thereof may be represented as T₁, T₂, . . . . Tₙ. Thus, the search query may be understood as a request to the search application 104 to locate every document within the data collection an index of which is maintained by the database 130 containing each and every one of the search terms T₁, T₂, . . . . Tₙ (the logical equivalent of an “AND” between the search terms; i.e., every document resulting from the search must contain at least one occurrence of the word Tᵢ, for every i from 1 to n). Alternatively, the search query may be understood as a request to the search application 104 to locate every document within the data collection an index of which is maintained by the database 130 containing at least the search terms T₁, T₂, . . . . Tₙ, as well as other terms.

Within these embodiments of the present technology, the server 116 is configured to access the search module 118 (to perform a general web search and/or a vertical search, for example, in response to the submitted search query). Within the embodiment depicted in FIG. 1, the server 116 is generally configured to:
(i) receive, from the electronic device 102, a search query (such as the search query entered through the search query interface 106;
(ii) conduct searches (by accessing the search module 118) to generate a search result list, the search result list containing a first search result and a second search result, both of which are responsive to the search query-within some embodiments of the present technology, the first search result being a vertical search result and the second search result being a web search result);
(iii) execute analysis of search results and perform ranking of search results to generate a ranked search results list (the process of generating the ranked search result list will be described in greater detail herein below);
(iv) group search results to generate the search results page (SERP) to be outputted to the electronic device 102 in response to the search query.

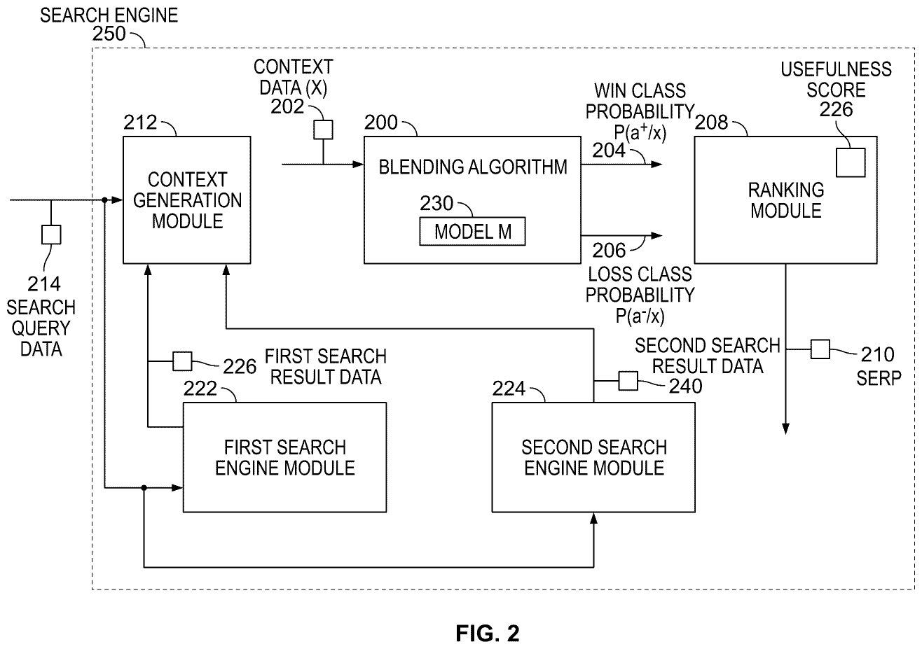

More specifically, the server 116 is coupled (or otherwise has access to) a first search engine module 222, a second search engine module 224 (see FIG. 2) and potentially further search engine modules. Each of the first search engine module 222 and the second search engine module 224 is configured to execute its respective machine learning algorithm. The specific implementation of the respective machine learning algorithm is not particularly limited and can include, broadly speaking, a supervised learning algorithm or a supervised machine learning algorithm. Examples of the supervised learning algorithms include (but are not limited to): Artificial neural network; Bayesian statistics; Case-based reasoning; Gaussian process regression; Gene expression programming; Group method of data handling (GMDH); Inductive logic programming; Instance-based learning; Lazy learning; Learning Automata; Learning Vector Quantization; Logistic Model Tree and the like.

The first search engine module 222 and the second search engine module 224 are described herein as being separate search engine modules but an integrated search engine approach is also feasible. The first and second search engine modules 222, 224 provide search result data to a blending algorithm as will be described in further detail with reference to FIG. 2. Generally, the first and second search engine modules 222, 224 provide search result data including content of different types such as widgets, vertical search result elements and web documents. The different types of search result content provided by the first and second search engine modules 222, 224 are processed by a blending algorithm 200 in order to determine where the search results are to be ranked relative to one another in a SERP of the search result interface 108.

The blending algorithm 200 of the present disclosure determines a rank of the search results based on a multi-classifier machine learning module that outputs for a given search result element a win class probability for each ranking position and a loss class probability for each ranking position. The ranking for the given search result elements (e.g. a widget) relative to other search result elements (e.g. a web document) is determined based on a difference between the win class probability and the loss class probability for each ranking position. That is, the blending algorithm predicts for each element of the search results of the first and second search engine modules 222, 224, a rank within the search results elements based on two classes (or components) that are combined to produce a usefulness score. The blending algorithm 200 may be a multi-arm bandit receiving context data including search query data generated based on user input to the search query interface 106, user parameters retrieved from the database 130 and the search result data and other parameters such as time of the search query. The blending algorithm optimizes a usefulness metric which shows how useful a given search element is at a selected SERP position. The usefulness metric is a function of the win class probability and the loss class probability. Detailed functionality of the blending algorithm 200 will be described further herein, particularly with reference to FIG. 2.

With reference to FIG. 2, there is depicted a schematic representation of a search engine 250 for receiving search query data 214 and generating a SERP including a ranked list of search results. The search engine 250 is implemented by the server 116 as shown in FIG. 1. The server 116 includes one or more processors (not shown) executing computer program instructions (not shown) to perform the various functions described with reference to FIG. 2. The server 116 includes a context generation module 212, a first search engine module 222, a second search engine module 224, a blending algorithm 200 including a model M 230 and a ranking module 208. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

The first search engine module 222 creates first search result data 226, which may include web content of a first type such as a list of web documents. Web documents may refer to individual web pages or online content that can be retrieved by a search engine in response to a user's query, which is embodied by search query data 214 that is input to the first search engine module. These web documents may include URLs (Universal Resource Locators) to websites: These are the web addresses (URLs) that lead to specific websites or web pages. In a search engine context, they are often presented as clickable links in the search results. The first search engine module 222 may additionally provide snippets, which are brief text excerpts or descriptions extracted from the web documents. In the end SERP 210, the snippets are usually displayed alongside the URLs in the search results to give users a preview of the content available on the linked web page. The snippets may alternatively be extracted by a module other than the first search engine module 222. Web documents can encompass a wide range of online content, including articles, blog posts, product pages, forum discussions, news articles, and more. Search engines index and rank these web documents based on their relevance to a user's query, and the search results typically include a list of URLs and their associated snippets. The first search result data 226 may be provided in the form of a ranked list by the first search engine module 222 for blending with content included in second search result data 240 from the second search engine module 224. The first search engine module 222, in combination with the blending algorithm 200, presents the selected web documents to the user in the form of the SERP typically including a title, a snippet (a brief description of the page), and a URL link. The order in which results are presented is determined by a ranking algorithm of the first search engine module 222 and include widgets or other content of the second search result data 240 that has been positioned in the SERP 210 by the blending algorithm 200.

The second search engine module 224 creates the second search result data 240, which may include web content of a second type such as widgets. The second search engine module 224 retrieves relevant second search result data 240 in response to search query data 214 generated based on a user's query entered to the electronic device 102. The blending algorithm 200 is engaged in inserting the widgets into the SERP at a determined ranking position relative to the content of the first search result data 226 to enhance the user experience and provide additional information or functionality. Widgets are typically designed to offer specific features or content related to a user's search query or context. Widgets can come in various forms and serve different purposes, such as those described previously herein. Widget can include:
Information widgets: These widgets provide supplementary information directly within the search results. For example, a weather widget might display the current weather conditions for a location mentioned in the search query.
Interactive widgets: These widgets allow users to interact with content or perform specific actions without leaving the search results page. For instance, a calculator widget enables users to perform calculations right in the SERP.
Media widgets: These widgets can display media content like videos, images, or audio files, making it easier for users to access and preview multimedia content related to their query.
Navigation widgets: Some widgets help users navigate to specific sections of a website or access certain features quickly. For example, a site link widget might offer direct links to key pages on a website.
Dynamic widgets: These widgets can update in real-time based on user interactions or changing data. For instance, a stock market widget may display live stock prices.

Widgets are intended to enrich the SERP 210 with relevant and useful content, reducing the need for users to click through to actual web documents. They aim to provide quick answers, previews, or actions that align with the user's search intent. The blending algorithm 200 is configured to incorporate widgets into the search results and determine their placement and relevance within the ranked results. Although the first search result data 226 is described primarily herein as including web documents and the second search result data 240 is described primarily herein as including widgets, the first search result data 226 and the second search result data 240 can include a various types of web content that may or may not be pre-ranked and which is to be combined in the SERP 210 according to an optimal ranking that maximizes relevance to a user whilst being processing efficient.

Web documents (or other types of web content including vertical web content like images, video, etc.) are generally provided by the first search engine module 222 through a combination of web crawling, indexing, and presentation mechanisms. In web crawling, the first search engine module 222 deploys web crawlers (also known as spiders or bots) to navigate the internet and collect web content. These crawlers start by visiting a list of seed URLs and then follow links on web pages to discover new content. They download web pages and associated assets like images, CSS, and JavaScript files. Once web content is crawled, the first search engine module 222, 224 performs an indexing process. During indexing, the first search engine module 222 extracts information from the web documents, such as text, metadata, and links. This extracted data is then stored in a structured format in the search engine's index. The index is stored in the database 130 that allows for efficient retrieval of relevant documents in response to user queries. When a user enters a search query through the electronic device 102 to generate the search query data 214, the first search engine module 222 processes the query to understand the intent of the query and retrieve relevant web documents from the index. This process involves ranking the web documents based on factors like relevance, authority, and freshness.

Widgets included in the second search result data 240 may be provided by the second search engine module 224 for insertion in the SERP 210 by the blending algorithm 200. However, in other embodiments, the blending algorithm 200 may obtain and insert the widgets itself based on context data 202 as described in the following. In either embodiment, the first search engine module 222 and/or the second search engine module 224 analyzes a query embodied by search query data 214 to understand the user's intent and context. This analysis includes identifying keywords, user location, search history, and other relevant information. Based on the query analysis, the first search engine module 222 retrieves a set of relevant web documents (traditional search results) from its indexed database 130 as described hereinabove. The first search engine module 222 and/or the second search engine module 224 assess the relevance of various widgets for the given query embodied by the search query data 214. These widgets may come from different sources, including the search engine itself, third-party providers, or external APIs. The first search engine module 222 and/or the second search engine module 224 selects widgets that are deemed relevant to the user's query. This selection may be influenced by various factors, such as the user's search history, location, device, and the query's context. Some widgets may be generated in real-time based on the search query and the selected web documents. Others may be pre-generated and stored for quick retrieval. The selected widgets, which may be included in the second search result data 240, are blended with the web documents in the first search result data 226 by the blending algorithm 200 and may be presented alongside the web document snippets in the SERP. The blending algorithm 200 ranks the integrated widgets relative to the web documents, considering both the relevance of the web documents and the widgets and according to a machine learning algorithm model M that is described in greater detail in the following to provide the most helpful and informative results to the user whilst being processing efficient.

The blending algorithm 200 receives context data (x) 202 that has been generated by the context generation module 212. The context data (x) 202 includes contextual information associated with a search query or a user's search session embodied by the search query data and is collated and formed by the context generation module 212. The specifics of what context data (x) includes can vary, but may encompass the following elements. The context data (x) 202 may include user profile data embodying information about the user, such as their search history, location, language preferences, device type, and demographic data. The context data can include the search query data 214 embodying the actual query entered by the user, including keywords and phrases, as well as the user's intent behind the query. The context data (x) 202 may include temporal context including the time and date of the search, which can influence the relevance of results (e.g., news updates, events, or time-sensitive information). The context data (x) 202 includes web documents or other web content provided in the first search result data 222 as part of the contextual information. These web documents or other web content represent the search results, which are retrieved and ranked based on the user's query and context by the first search engine module 222. The context data (x) 202 may include the widgets or other web content to be inserted in the SERP according to a ranking determined, at least in part, by the blending algorithm 200. The context data (x) 202 may include geographical context representing the user's location or geographic area, which can affect the relevance of results (e.g., local businesses, weather, or events). The context data (x) 202 may include session context representing information about the user's current search session, including previous queries, interactions, and session duration. The context data (x) 202 may include device context representing the type of the electronic device 102 used for the search (e.g., desktop, mobile, tablet) and its capabilities. The context data (x) 202 may include behavioral context, which includes data related to the user's behavior, such as click-through rates, dwell time on pages, and previous interactions with search results. The context data (x) 202 may include social context representing information from the user's social media profiles or connections that may influence the results or widgets displayed. The context data (x) may include personalization representing any user-specific preferences, such as preferred news sources, favorite websites, or interests. The context data (x) 202 may include external Data representing data from external sources, APIs, or databases that can provide additional context, such as weather conditions, stock market data, or live sports scores. The context data (x) 202 is used to tailor the search results and widgets to the user's specific needs and preferences. By considering these contextual elements, search engines aim to provide a more personalized and relevant search experience. The possibilities for incorporating context into search results are vast and can continue to evolve with advancements in technology and user data analysis. By incorporating the user's context, such as their profile, intent, location, and other factors, along with the content of web documents and widgets, the blending algorithm 200 aims to provide a personalized and relevant search experience. This is achieved by ranking the widgets and web documents based on their relevance to the user's context.

In embodiments, the blending algorithm 200 includes a trained artificial intelligence model M 230. The blending algorithm 200, specifically the model M 230, receives the context data 202 and outputs a win class probability 204 and a loss class probability 206. That is, the blending algorithm 200 determines a ranking score for a particular web content element (e.g. a widget from the second search result data 240 to be inserted into ranked web documents of the first search result data 226) based on the model M, which represents, in combination with the ranking module 208, a trained ranking machine learning system to predict a usefulness score 226 for the selected element for each position based on two components:
the loss class probability 204 (a loss_weight), which represents a prediction of a signal of a user not clicking (or otherwise selecting or some other engagement indicator) the web content element at the selected position. The loss class probability 204 is trained based on training data in which a user has not clicked (or otherwise selected or some other engagement indicator) the selected web content element at the selected position. This is a negative training target; and
the win class probability 204 (or a win_weight), which represents a prediction of a signal of a user clicking (or otherwise selecting or some other engagement indicator) the selected element in the selected position. The win class probability 204 is a positive training target based on training data in which a user has clicked (or otherwise selected or some other engagement indicator) the selected element in the selected position—this is a positive training target.

A final usefulness score 226 is determined, by the ranking module 208, based on a difference between the values of the win class probability 204 and the loss class probability 206.

The blending algorithm 200 and the ranking module 208, during an in-use phase of the ranking system, receives an in-use query from a user (included in the context data (x) 202) and generates a ranked list of web content elements for production in the SERP 210. For determining a ranked position for each web content element in the ranked list of elements (to be placed in the final SERP 210), the blending algorithm 200 determines, for each web content element, two probabilities (win class probability 204 and loss class probability 206) or weights for both hypothesis when the user either selects (or otherwise engages) with the specific element or not. The final ranking score is determined by the ranking module based on a usefulness score 226 representing a difference between win class probability 204 and loss class probability 206. Thus, the blending algorithm 200 is a multi-class classification engine that predicts, based on the input context x, the probability of a widget or other web content element at each ranking position of a set of “a” possibilities both the win class probabilities P_(M) (a\hat{ }+|x) and the loss class probabilities P_(M) (a\hat{ }_|x) using the trained model M.

In embodiments, the model M 230 operates to predict and classify actions based on the provided context data (x) 202. The input to the blending algorithm 200 including the model M 230 includes context data (x) 202, which is a feature vector. This vector contains various features or information that describe the current search context, including user intent, search query, user profile, location, device type, and any other relevant information as described previously. In particular, the context data (x) 202 includes the features of the search request (based on search query data), user information, and the issuance of web documents according to the first search result data 226. The context data (x) 202 serves as the basis for making predictions. A primary output of the model M 230 is the classification of actions into two classes: a+ (positive class) and a− (negative class). For each action a and given context x, the model predicts the probability that the action belongs to the positive class (P(a+|x)) (win class probability 230) and the probability that it belongs to the negative class (P(a−|x)) (loss class probability 206). The model M 230 is designed as a multiclassification model. For each action a and context x, it predicts the probabilities of two classes: a+ and a−. These probabilities indicate how likely it is that the action will result in a positive outcome (a+ class) or a negative outcome (a-class) within the given context. A positive outcome is some indicator of the user interacting with the web content element at the given position and a negative outcome is some indicator of the user not interacting with the web content element at the given position. For each candidate action a, the model M 230 calculates two probabilities: P(a+|x) (win class probability 204) and P(a−|x) (loss class probability 206). These probabilities represent the likelihood that taking action a will lead to a positive or negative outcome in the current context. The model may use its internal parameters, which were learned during training, to make these probability predictions. Once the probabilities are calculated for all candidate actions, they can be used to rank the actions based on the difference between P(a+) and P(a−), which corresponds to the usefulness score 226. This ranking step may be performed by the ranking module 226. Actions with a higher positive-negative probability difference are ranked higher, indicating their predicted desirability. The ranking module 226 may select the action (ranking position) with the maximum value of (P(a+|x)−P(a−|x)) as the most desirable action for the given context x. If the maximum difference value is less than zero, indicating that none of the actions are predicted to have a positive outcome in the context, then the ranking module may recommend “non-showing” actions, meaning that the web content element or widget will not be displayed to the user in the SERP 210.

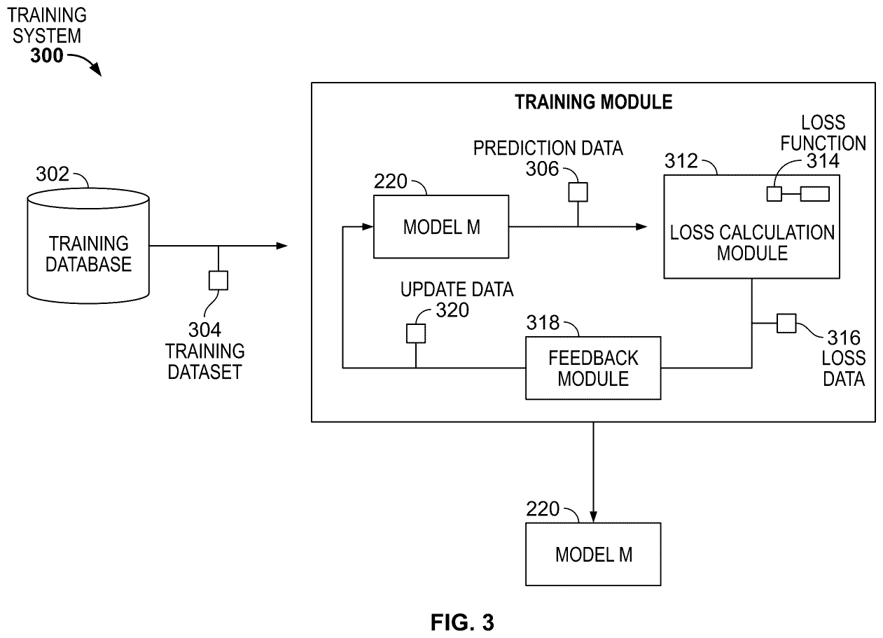

With reference to FIG. 3 there is depicted a schematic illustration of a training system 300 including a training module 310. The training module 310 is responsible for training of a machine learning algorithm, specifically the blending algorithm 200 including the model M 230. The training system 300 including the training module 310 is executed by one or more processors (shared, dedicated, or group) and memory that executes one or more software or firmware programs, a combinational logic circuit, and/or other suitable components that provide the described functionality. The one or more processors may be stored on the server 116. The training system 300 includes a training database 302 providing a training dataset 304 for use in training the model M 220. The training module 310 uses the training dataset 304 and a loss function 314 to produce loss data 316 that allows updating of parameters of the model M 220 through feedback 318 and associated update data 320.

Before describing detailed operation of the training module, some mathematical description of the underlying technology is instructive. A metric that is maximized during training is called surplus s. In the case of each particular widget or some other web content element, the specific manner of calculating surplus can differ but the surplus is generally equal to win-loss. A win is a metric indicative of a useful interaction with the widget. For example, a click or other engagement indicator with a given live time can provide a win metric. A loss metric may be associated with interacting with a web document or other content under a selected position of the widget in a ranked SERP. For example, a click (or other engagement) indicator multiplied by a ratio of the widget's pixel height at the selected position to the user selected web content under the widget may serve as a loss metric. Win and loss metrics can vary depending on the specific context, the web content being ranked and other factors. Exemplary win indicators, when engaged at the selected position, include Click-Through Rate (CTR), conversion rate, engagement time, scroll depth (for widgets that contain scrollable content, the depth to which users scroll within the widget can serve as a win metric), sharing or social metrics. Exemplary loss indicators can include any of the win metrics when one of the widgets or other web content below the selected position is so engaged.

In the training system 300, randomized data collection is conducted to train the Model M 220. Under randomized data collection, the widget (or other web content) is embedded in the search results in a random place. That is, the training dataset 304 provides training search results as though from the first search engine module 222 and a widget (or other web content element) for positioning therein. The position may be chosen at random under the randomized data collection training scheme. The model M 220 is trained by the training module 310 based on a loss function 314 that can be of various forms but requires an appreciation of the following mathematical notations:
A is a set of actions from which the model M 220 selects. In one example, A={a₀a₁ . . . a₁₀₀} with a0, . . . a9 showing the widget in ranking positions from 0 to 9, and a100 is not showing). That is, A is a set of actions indicating a position of a web content elements to be inserted in search results and displayed in a SERP 210. There is a finite number of ranking positions in the SERP 210 that can be selected.
X represents various contexts including user information, search query and search results in which a widget is to be in.
S_{a,x} is a surplus that is calculated by selecting the action a in the context x and is a random variable.
E_{S}_{_{a,x}} is an expectation of a surplus resulting from action a in context x.
P_{M} (a|x) is a probability mapped to the action a of the model M in context x i.e., with features x according to the context data 202.
a_{M}(x) is an action selected by the model M 220 in the context x.
a_{rnd}(x)—the action of which selects a random collection in context x (a random variable that takes values in the set A).

The training dataset 304 provided by the training database includes N random collection data points. The ith query gives a training example of the form (wᵢ, xᵢ, aᵢ, sᵢ), wherein:
xᵢ—features of a specific request in the training dataset 304, which may include user data and web content (e.g. web documents) from a search query and the search query itself (or features thereof. That is, xᵢ represents the context data 202 for the ith query in the training dataset 304.
aᵢ is an action randomly selected for that query where the action represents, in examples, a ranked positioning of a widget or other web content in the search results.
sᵢ is the surplus on the its request
wᵢ is the weight of the request,

$$\frac{1}{P ( {a}_{rnd} ( {x}_{i} ) = {a}_{i}} .$$

The weight (wᵢ) of each request is determined based on the probability (P) that the randomly selected action (a_rnd) for that request matches the actual action (a_i) that was observed. The inverse of this probability is used as the weight, indicating how significant this specific request is within the training dataset.

In one concept provided by way of comparison to the present technology, the model M 220 is trained by calculating the surplus of the model M as:

$$\frac{1}{N} {\sum }_{i} {w}_{i} [ {a}_{i} = {a}_{M} ( {x}_{i} ) ] {s}_{i} \qquad ( equation 1 )$$

Equation 1 calculates the expected value by averaging over N instances in the training dataset 304, where N represents the total number of instances. [a_i=a_M(x_i)] is an indicator function that evaluates to 1 when a_i (the action associated with the i-th instance) is equal to the action predicted by the model a_M(x_i) based on context x_i. It evaluates to 0 when they are not equal. The indicator function [a_i=a_M(x_i)] ensures that only the instances where the model's predicted action matches the actual action (a_i=a_M(x_i)) will contribute to the overall expected value of the surplus. Instances where the predicted action doesn't match the actual action (a_i≠a_M(x_i)) will have a contribution of 0. In essence, this equation captures the expected value of the surplus for the instances where the model's action prediction aligns with the actual action.

The inventors of the present technology take a more nuanced approach to evaluating the overall surplus when training the model M 220 by more directly maximizing the surplus. The formula for training the model M 220 does not select a position or action a but gives some probability distribution to the possible positions. That is, the training module optimizes a metric estimating the overall surplus when a ranking position or action is randomly selected in accordance with a given distribution. This metric can be referred to as a smoothed offline surplus:

$${\sum }_{i} {P}_{M} ( {a}_{i} \vert {x}_{i} ) {w}_{i} {s}_{i} \qquad ( equation 2 )$$

Where P_{M}(aᵢ|xᵢ) is the probability mapped by the model M position aᵢ in the context xᵢ

That is, the training module 310 The new model maximizes equation 3 or, alternatively, equation 4 below.

$$\frac{1}{N} {\sum }_{i} ( {w}_{i} {s}_{i} ) log {P}_{M} ( {a}_{i} \vert {x}_{i} ) \qquad ( equation 3 )$$

$$\frac{1}{N} {\sum }_{i} ( {w}_{i} {s}_{i} ) {P}_{M} ( {a}_{i} \vert {x}_{i} ) \qquad ( equation 4 )$$

Equations 3 and 4 represent a loss function 314 utilized the training module 310 to determine loss data 316 to generate updated parameters (weights), via update data 320, for the model M 220 utilizing feedback module 318. The training module 310 utilizes random data collection from the training database 302, where an action a is randomly selected. The training module 310 aims to enhance the multiclassification aspect of the model. The training process begins with a set of N random data collection requests from the training module 310 to the training database 302. For each request, the training dataset 304 includes features of a user search request (xi), which encompasses various aspects related to the user, delivery of web documents by a search engine, and the other aspects of the context in which the request is made. The training dataset 304 for each request includes an action (ai) is randomly selected from the set of possible actions (A), where the action represents what the model should predict. The training dataset 304 for each request includes surplus (si) associated with that particular request. The surplus reflects the difference between the benefits and costs of taking the action ai in context xi. The training dataset 304 for each request includes weight (wi), which measures the importance of the request and is calculated as the inverse of the probability of the model's prediction matching the actual action.

The model M being trained is designed for multiclassification. It aims to predict the probability of each action, P_M(a|x), for a given context x. The training module 310 trains the model M 220 using policy gradient. A goal is to maximize the expected surplus. The model's policy, which assigns probabilities (P_M) to actions in various contexts, is optimized to achieve this. The loss calculation module utilizes a policy gradient loss function for training according to equations 3 or 4 or similar loss functions that include a weight w_i associated with each request, a surplus s_i obtained for each request and a predicted probability of selecting action a_i in context x_i (P_M(a_i|x_i)). The loss data 316 produced by the loss function 314 is received by the feedback module 318, which employs a policy gradient ascent method, which adjusts the policy probabilities (P_M) in a direction that increases the expected surplus. The feedback module 318 provides update data 320 through which the model M 220 is updated iteratively based on the gradients derived from the policy gradient loss function 314. These updates adjust the action probabilities to maximize the expected surplus. The feedback module 318 may employ an optimization algorithm, like stochastic gradient ascent or natural policy gradient method, to efficiently find the policy that maximizes surplus. The training process is iterative, where the model M 220 continues to learn and adjust its policy until convergence is reached. The ultimate goal of this training process is to train the model M 220 to assign the highest probability to actions that result in the maximum surplus, optimizing the system's performance for delivering relevant content in response to user queries.

The training moule 310 is configured so that each surplus earned during the random data collection (and included in the training dataset 304) is turned into a training example for multiclassification. The features (context data (x) 202) of each example in the training dataset 304 describe the context in which the surplus was earned. The target for training the model M 220 is an action by which the surplus was earned. That is, training module 310 is configured determine the probability of how the random collection earned the surplus in the context of x. For the multiclassifier model M 220, PM (a|x) is the probability that the surplus was earned using the action a. For N examples in the training dataset 304, the probabilities PM(a|x), are selected during training for a fixed context x under a policy gradient training scheme based on the target of the chosen random action and the associated surpluses that have been earned.

As a further development of the training process, the training module 310 performs a training process as outlined above but includes a winning and losing training target pair. For each action a, there is two classes a+ and a−, and from each request (with context features x, position a and weight w), two training examples are provided in the training dataset 304 for training multiclassification. A win example includes: feature x, weight Win W (metric representing user engagement at the given ranking position) and target a+ and a losing example includes: feature x, weight Loss W (metric representing user engagement at a lower ranking position) and target a−. In some examples, a user engagement with a particular element at the given ranking position may have occurred simultaneously with a user engagement with a particular element below said ranking position (say, during the same web session). In such a case, the training data includes both weight Win W and weight Loss W at the same time, wherein the same training example provides both winning and losing examples. That is, a losing example is one where the user interaction results in a positive loss (a loss_weight>0), and a winning example is one where the user interaction results in a positive win (a win_weight>0). Still under the example of above, the win_weight may be 0.3 and the loss_weight may be 0.1. The model M 220 is thus trained to provide, for a given context data x (202), a win class probability 204 (the probability of the user interacting with any of the actions a in the set A at that ranking position) and a loss class probability 206 using the loss function and policy gradient techniques described in the foregoing. In embodiments, depending on a specific user engagement scenario, the training module 310 performs a training process based on: (i) a win_weight and a loss_weight both to be equal to zero (0) based on receiving no user engagement with a particular element, therefore a selected training example is being excluded (is not being added to) from the training dataset 304; (ii) the particular element receives a win_weight and a zero (0) loss_weight based on having a prolongated user engagement with the selected element, hence a winning example is being added to the training dataset 304; (iii) the particular element receives a loss_weight and a zero (0) win_weight, resulting into a losing example to be added to the training dataset 304; and (iv) a particular element receives both a win_weight and a loss_weight based on receiving user engagement with the given element and another element below the given element's position, wherein the training dataset 304 receives a pair of training examples: a winning example and a losing example.

The training module 310 is designed two use two weights a loss_weight and a win_weight as described above. The loss weight includes a surplus score value for the selected element in case the selected element loses (a lower ranked action a is taken by the user) given context x and action a in the training example the win weight provides a surplus score value for the same element in case the selected element wins (the action a is taken by the user given the context x). Put another way, for the features set x a win_weight is associated with a positive target action a+, while the features set x and the loss_weight is associated with a negative target action a−. Therefore, two training examples for the multiclassification task are obtained from the training dataset 304 representing win and loss examples. The probabilities output by the model M 220 for the loss class and the win class are adjusted by the feedback module under a policy gradient scheme in an iterative manner in order to minimize the loss function 314 such that the model M 220 is trained to output, given context x, the probability distribution for the win class P_{M*}(a⁺|x) and for the loss class P_{M*}(a⁻|x). At run time, the action a having the maximum difference (usefulness score) in probability between the win class and the loss class is determined by the ranking module 208 and used to set the ranking position of the selected widget in the SERP 210.

It should be noted that the surpluses s and the associated weight w may be selected for each type of content to be inserted (whether a widget or other type of web content element). In some cases, a single target metric may be selected for all types of content to be used as an indicator of user engagement of a particular ranking position or action and from which the surplus values are derived. For example, click through rate (CTR) may be selected for the web-type content, long-clicks may be selected for the video-type content and another user engagement metric may be selected for the image-type content. In another example, CTR (or any other common target metric) may be selected for all types of content. The described technology may be used in a combination providing additional scores (weights) associated with each of the web search results elements.

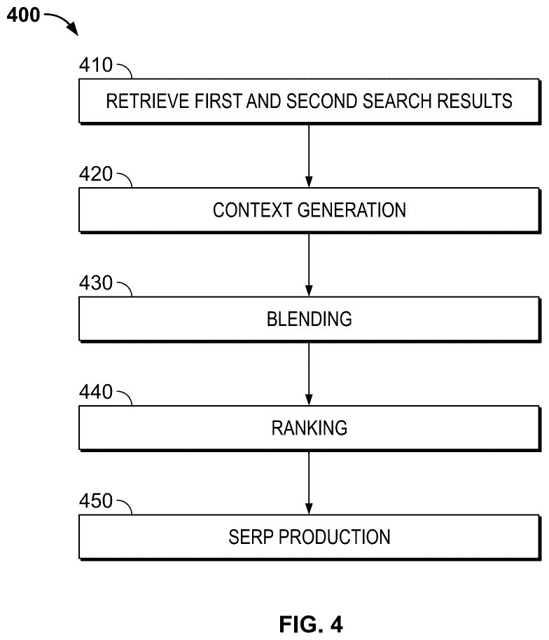

Given the architecture described above it is possible to execute methods for generating a search engine results page (SERP) 210. With reference to FIG. 4, there is depicted a method 400, the method 400 being implemented in accordance with some non-limiting embodiments of the present technology. The method 400 can be executed by the server 116.

A user initiates a search query with the search engine 250 by interaction through the search query interface 106 on the electronic device 102 of the user. Data embodying the search query is sent over the communication network 110 to the server 116. The server 116 includes, or is associated with, the first search engine module 222, the second search engine module 224 and the blending algorithm 200.

In step 410, first and second search results are retrieved by the server 116 from the first and second search engine modules 222, 224 based on the search query data 214. The first and second search results are provided as first and second search result data 226, 228 and may include different types of web content from each other. For example, the first search result data 226 may include a ranked list of web documents and the second search result data 240 may include one or more widgets to be inserted in the first search results at a position determined by the blending algorithm 200 and the ranking module 208.

In step 420, context data (x) 202 is generated by the context generation module 212. The context data (x) 202 includes context features (x) capturing information about the user, the web documents (or other ranked web content elements from the first search engine module 22), the search query data 214 and the widget to be inserted (or other web content element). The context features may include user data, document characteristics, and widget attributes.

In step 430, blending is performed whereby the search engine 250 employs the model M 230, which has been trained to predict actions (positions) in search results based on the context data (x) 230. The model M 230 calculates action probabilities for each potential action (position) (within a set of possible actions A) in the search results. These probabilities are based on the context features and historical training data. That is, the blending step 430 includes the blending algorithm 230 employing the model M to determine probabilities associated with ranking position as a result of the widget being inserted in the web documents (for example) list at that position. The model M 230 provides for each action (position), two probabilities. A Win Class Probability (P_(M*)(a\hat{ }+|x)) 204 is provided, which is a probability of a positive outcome (the probability of a win in terms of a user engaging with the web content element at that position (action a). A Loss Class Probability (P_(M*)(a\hat{ }−|x)) 206 is provided, which is a probability of a negative outcome (the probability of a loss in terms of a user engaging with a web content element under, in the ranking order, the selected position).

In ranking step 440, the search results from the first search result data 226 and the search results from the second search result data 240 are ranked based on a difference (usefulness score 226) between the win class probability 204 and the loss class probability 206 for each action as determined by the ranking module 208. The action (or position) with the highest usefulness score is selected as the position to insert the web content element into the first search results, e.g. where the widget is to be inserted in the web documents.

In step 450 the SERP 210 is produced by the server 116 by the search engine 250 compiling the ranked web documents (or other web content elements) and widgets (or other web content elements) to create the final SERP 210. The SERP 210 is communicated, over the communications network 110, to the electronic device 102 for output on the search result interface 106. The SERP 210 is presented to the user, showing the most relevant and useful content based on the model's predictions and the context. The user may interact with the search results, widgets, and web documents on the SERP 210, potentially influencing future context generation and model predictions through an ongoing training and refinement of the model M 220.

This method 400 leverages context features, model blending, and probability estimates to provide more personalized and relevant search results to the user, taking into account both web documents and widgets, ultimately enhancing the search experience.

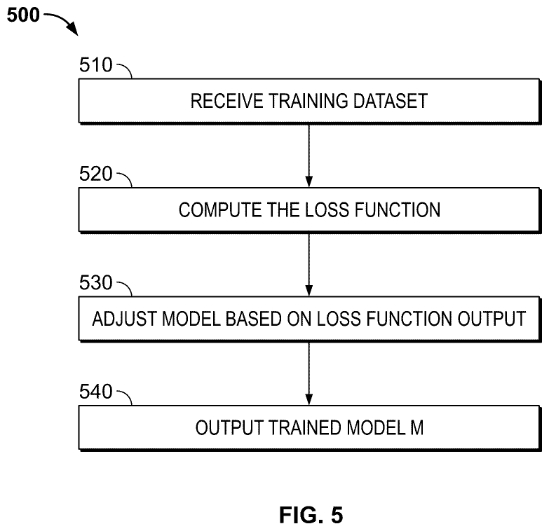

With reference to FIG. 5, there is depicted a flow chart of a method 500 of training the model M 220 of the blending algorithm 200, the method 500 being implemented in accordance with other non-limiting embodiments of the present technology. The method 500 can also be executed by the server 116 running the training module 310 or some other computing system for operating the training module 310.

The model M 220 is initialized with initial parameters. In step 510, the training dataset 510 is received from the training database 302. The training dataset 304 is collected from actual user interactions with a search engine. It includes various requests made by users during their search sessions and the associated search results, user information, user engagement information, etc. For each request, an action (a) is randomly selected from a set of possible actions (positions or results) available on the search engine result page (SERP). Context features for each request are extracted. These features describe the user's query, historical behavior, search results, device type, location, and other relevant information. The surplus(s) for each request is determined or is included as a data label. Surplus represents the difference between positive outcomes (e.g., clicks, engagement) and negative outcomes (e.g., non-engagement) for the selected action.

Initial action probabilities for each action based on context features and win class probability (P_(M*)(a\hat{ }+|x)) and loss class probability (P_(M*)(a\hat{ }−|x)) are also initialized.

In step 520, the loss function is computed according to equation 3 or equation 4 as described above. To do so, the model predicts the probabilities of actions (P_M(a|x)) in a given context and based on the surplus and weights from the training dataset 304 and minimizes the loss function to obtain loss data 316.

In step 530, the model M 220 is adjusted based on the results of the loss function calculation in step 520. In embodiments action probabilities ((P_M(a|x)) are adjusted using, for example, policy gradient feedback to minimize the loss calculated by the loss function 314. The model parameters are updated to optimize the action probabilities. The step 530 is performed iteratively until a convergence criteria has been met (e.g. the overall smoothed offline surplus (equation 2) meets some predetermined criteria or a certain number of iterations have been performed).

In step 540, the trained model M 220 is output and ready for use in ranking and blending actions at runtime.

Win and loss training examples are used to produce two distinct classifications by the model M 220: a win class probability and a loss class probability. That is, the model is trained with win and loss examples in the training dataset to teach probabilities of a particular action (position) resulting in a loss (non-engagement by a user) and a win (engagement by a user). At run-time, the action (position) in which there is a maximum difference between the win and loss class probabilities is the selected position in the SERP 210.

Again, it should be understood that the procedure set forth above is simply an illustrative embodiment of the present technology. It is not intended to define or limit the scope of the present technology.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

Accordingly, embodiments described above can be summarized as follows, presented in numbered clauses.

1. A method of generating a Search Engine Results Page (SERP), the SERP to be provided to an electronic device associated with a user of a search engine hosted by a server, the server being communicatively coupled with the electronic device, the method executable by the server and comprising:
acquiring query data from the electronic device, the query data being indicative of a query submitted by the user;
determining a set of web content elements based on the query data including a given web content element, the set of web content elements including relevant search results for the query;
generating context data from the set of web content elements and the query data;
feeding the context data to a model, the model being a multiclassification model for a plurality of classes,
the plurality of classes including two classes dedicated to a given ranking position on the SERP, the two classes being:
a win-dedicated class indicative of a predicted benefit of the given web content element being ranked at the given ranking position on the SERP, and
a loss-dedicated class indicative of a predicted detriment of the given web content element being ranked at the given ranking position on the SERP;
generating a metric value for a given web content element-position pair, the given web content element-position pair including the given web content element and the given ranking position,
the metric value being a difference between a predicted benefit value of the win-dedicated class by the model for the given web content element and a predicted detriment value of the loss-dedicated class by the model for the given web content element,
the metric value being indicative of an overall usefulness of ranking the given web content element at the given ranking position;
generating the SERP with the given web content element being ranked at the given ranking position based on the metric value.

2. The method of claim 1, wherein the model is configured to output probabilities for each ranking position of a set of ranking positions for each of the win dedicated class and the loss dedicated class and to determine the metric value for each of the ranking positions for the set of ranking positions, wherein the maximum difference is selected as the given ranking position for the ranking position of the given web content element in the SERP.

3. The method of claim 1, wherein the given web content element is a widget to be inserted in web documents included in the relevant search results for the query.

4. The method of claim 1, wherein the context data includes ranked web documents from a first search engine.

5. The method of claim 1, wherein the win-dedicated class corresponds to a probability of a user engagement with the given web content element at the given ranking position.

6. The method of claim 1, wherein the loss-dedicated class corresponds to a probability of a user engagement with another web content element below the given ranking position.

7. A method of training a model for ranking objects on a Search Engine Results Page (SERP), the SERP to be provided to an electronic device associated with a user of a search engine hosted by a server, the server being communicatively coupled with the electronic device, the method executable by the server and comprising:
acquiring query data associated with a training query, the training query being a previously submitted query to the search engine for which a training web content element has been provided as a search result at a given ranking position;
acquiring context data associated with the training web content element, the context data including the query data;
acquiring user-interaction data associated with the training web content element, the user-interaction data being indicative of (i) a benefit of the training web content element having been ranked at the given ranking position in response to the training query and (ii) a detriment of the training web content element having been ranked at the given ranking position in response to the training query;
generating two training sets for a training query-web content element pair, the training query-web content element pair including the training query and the training web content element, the two training sets including:
a positive training set having an input and a first label, the input having the context data, the first label being indicative of a ground-truth benefit of the training web content element having been ranked at the given ranking position in response to the query;
a negative training set having the input and a second label, the second label being indicative of a ground-truth detriment of the training web content element having been ranked at the given ranking position in response to the query;
training the model using the positive training set and the negative training set, the model being a multiclassification model for a plurality of classes,
the plurality of classes including two classes dedicated to the given ranking position, the two classes being:
a win-dedicated class indicative of a predicted benefit of the training web content element being ranked at the given ranking position, and
a loss-dedicated class indicative of a predicted detriment of the training web content element being ranked at the given ranking position.

8. The method of claim 7, wherein the model is configured to output probabilities for each ranking position of a set of ranking positions for each of the win dedicated class and the loss dedicated class.

9. The method of claim 7, wherein the training web content element is a widget to be inserted in web documents included in relevant search results for the query.

10. The method of claim 7, wherein the win-dedicated class corresponds to a probability of a user engagement with the training web content element at the given ranking position.

11. The method of claim 7, wherein the loss-dedicated class corresponds to a probability of a user engagement with another web content element below the given ranking position.

12. The method of claim 7, wherein the model is configured to output probabilities for each ranking position of a set of ranking positions for each of the win dedicated class and the loss dedicated class, and wherein the training includes adjusting the model to minimize a difference between the output probabilities and probabilities indicated by the positive training set and the negative training set.

13. The method of claim 7, wherein the training includes random data collection by which the given ranking position is randomly selected.

14. The method of claim 7, wherein the positive training set represents an example when a user interacted with the training web content element at the given position in the given context; and the negative training set represents an example when a user interacted with the training web content element at a ranking position beneath the given position, and wherein the training adjusts the model M to predict probabilities of both the win dedicated class and the loss dedicated class.

15. A system for generating a Search Engine Results Page (SERP), the system including a server configured to provide the SERP to an electronic device associated with a user of a search engine hosted by the server, the server being communicatively coupled with the electronic device and configured to:
acquire query data from the electronic device, the query data being indicative of a query submitted by the user;
determine a set of web content elements based on the query data including a given web content element, the set of web content elements including relevant search results for the query;
generate context data from the set of web content elements and the query data;
feed the context data to a model, the model being a multiclassification model for a plurality of classes,
the plurality of classes including two classes dedicated to a given ranking position on the SERP, the two classes being:
a win-dedicated class indicative of a predicted benefit of the given web content element being ranked at the given ranking position on the SERP, and
a loss-dedicated class indicative of a predicted detriment of the given web content element being ranked at the given ranking position on the SERP;
generate a metric value for a given web content element-position pair, the given web content element-position pair including the given web content element and the given ranking position,
the metric value being a difference between a predicted benefit value of the win-dedicated class by the model for the given web content element and a predicted detriment value of the loss-dedicated class by the model for the given web content element,
the metric value being indicative of an overall usefulness of ranking the given web content element at the given ranking position;
generate the SERP with the given web content element being ranked at the given ranking position based on the metric value.

16. The system of claim 15, wherein the model is configured to output probabilities for each ranking position of a set of ranking positions for each of the win dedicated class and the loss dedicated class and to determine the metric value for each of the ranking positions for the set of ranking positions, wherein the maximum difference is selected as the given ranking position for the ranking position of the given web content element in the SERP.

17. The system of claim 15, wherein the given web content element is a widget to be inserted in web documents included in the relevant search results for the query.

18. The system of claim 15, wherein the context data includes ranked web documents from a first search engine.

19. The system of claim 15, wherein the win-dedicated class corresponds to a probability of a user engagement with the given web content element at the given ranking position.

20. The system of claim 15, wherein the loss-dedicated class corresponds to a probability of a user engagement with another web content element below the given ranking position.
